(19) United States
(12) Patent Application Publication
(10) Pub. No.: US 2007/0133994 A1
(43) Pub. Date: Jun. 14, 2007

(54) Automatic frequency hopping remote controller

(75) Inventor: Chung-Ping Chi, Chung Ho City (TW)

Correspondence Address: HDSL, 4331 STEVENS BATTLE LANE, FAIRFAX, VA, 22033, US

(73) Assignee: Topseed Technology Corp.

(21) Appl. No.: 11/297,367

(22) Filed: Dec. 9, 2005

(51) Int. Cl. H04B 10/00

(52) U.S. Cl. 398/115; 340/825.72; 341/176

(57) ABSTRACT

An automatic frequency hopping remote controller automatically switches its channel when the transmission of a remote control signal is interfered. The remote controller includes a transmitting end and a corresponding receiving end; the transmitting end includes a first signal transceiver capable of transmitting signals through several channels and an input device, such that the remote control signal can be transmitted from a predetermined channel by a trigger instruction of the input device, and the receiving end is a second signal transceiver installed in an electronic device for receiving the remote control signal from the transmitting end. If the quality at a received signal is evaluated as poor, the remote controller will automatically switch to another receiving channel and send a frequency hopping signal to the transmitting end, so that the transmitting end will switch to that channel correspondingly, and the next remote control signal will be transmitted through that channel.

### BACKGROUND OF THE INVENTION

1. Field of the Invention

The present invention relates to a wireless remote control device with a frequency hopping function, and more particularly to a radio frequency (RF) remote control device having an automatic frequency hopping function.

2. Description of Prior Art

Remote controllers have been used extensively for the control of various electric appliances such as projectors, video recorders, and televisions, etc., and the remote controller employing the infrared signal transmission technology is more popular than others. Infrared remote controllers are applicable to a small and close area, and thus the infrared transmission is a good choice for the low-end short-distance control. On the other hand, infrared remote controllers come with a drawback that its infrared transmission may be hindered easily by long distance or obstacles.

More specifically, infrared provides a low-cost wireless transmission, and an infrared device transmits a signal forward in a narrow angle of the sector (approximately 60 degrees). Since the wavelength of an infrared ray is long, its penetrating power and reflectivity are relatively low and the infrared ray can hardly pass through an obstacle or reflect from a wall to achieve successful receipts of signals at a receiving end. Furthermore, the transmission power of a general infrared remote controller is low, and the transmitting distance is very limited, which is usually less than 5 meters. Obviously, the use of an infrared remote controller is restricted by the angle of transmission, distance, and obstacles.

As the radio frequency (RF) technology becomes well developed, many small wireless electric appliances or equipments adopt the radio frequency technology for the signal transmission. With the characteristics of the high-frequency electromagnetic wave, omni-directional, highly penetrating and reflective signal transmissions can be accomplished.

However, the radio frequency signal also has the interference issue, and most of the interferences are not caused by the signal itself, but are external interferences. For example, the interference come from other wireless products having the same frequency band, and wireless equipments such as wireless networks, wireless telephones, and wireless audio/video signal transmitting systems have an increasingly serous problem with the interference of radio frequency signals. As a result, the signals transmitted from the transmitting end cannot be received successfully at the receiving end.

In the above description, an infrared remote controller is unable to overcome the limitations of space and distance. Compared with the infrared technology, the radio frequency technology has less limitations and higher economic benefits. However, the radio frequency technology is limited by products with the same frequency band, and thus an improved remote controller is needed to provide a better quality for the remote control applications.

### SUMMARY OF THE INVENTION

The present invention is to overcome the limitations of space and distance of a prior art remote controller by using radio frequency signals for transmitting information between the data transmitting end and the data receiving end.

Another, the present invention is to overcome the signal interference at the channels of a remote controller. Since external factors are inexorable and difficult to overcome and avoid, therefore the data transmitting end and the data receiving end of the automatic frequency hopping remote controller have a plurality of predetermined channels, and the receiving end can determine the channel used by the receiving end during a transmission, and synchronously switch the channels with the transmitting end to assure a successful transmission of the remote control signals.

Further, the present invention is to use a transmitting end to simultaneously transmit signals to a plurality of receiving ends. To avoid the situation that each receiving end is unable to determine the receivable signals and data, a manufacture ID is added to the signal for identifying the signals and data.

The automatic frequency hopping remote controller in accordance with the present invention can automatically switch its channel if the transmission of remote control signals is interfered. A channel selector of the remote controller comprises: a transmitting end including a first signal transceiver and an input device, and a trigger instruction of the input device is provided for transmitting a remote control signal; and a receiving end being a built-in second signal transceiver of an electronic device for receiving the remote control signal from the transmitting end and evaluating the quality of the received signals. The receiving end will automatically switch its channel, if the signal quality is poor, and also will send a frequency hopping signal to the transmitting end to simultaneously switch the transmitting channel, so as to assure a successful signal transmission.

The above summaries are intended to illustrate exemplary embodiments of the invention, which will be best understood in conjunction with the detailed description to follow, and are not intended to limit the scope of the appended claims.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic block diagram showing a one-to-one control mode of an automatic frequency hopping remote control device of the present invention;

FIG. 2 is a channel planning table of a transmitting end and a receiving end as depicted in FIG. 1;

FIG. 2A shows a channel editing table as depicted in FIG. 2;

FIG. 3 is a flow chart of a preferred embodiment of the present invention;

FIG. 4 is a schematic block diagram of a one-to-many control mode of an automatic frequency hopping remote control device of the present invention; and

FIG. 4A shows a channel planning table of a transmitting end and a receiving end as depicted in FIG. 4.

### DETAILED DESCRIPTION OF THE INVENTION

The technical characteristics, features and advantages of the present invention will become apparent in the following detailed description of the preferred embodiments with reference to the accompanying drawings.

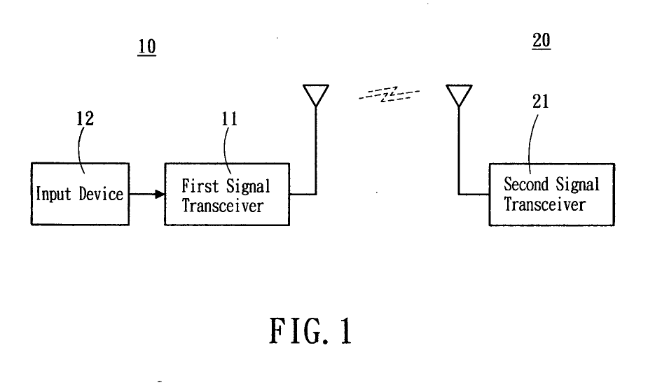

Referring to FIG. 1 for the schematic block diagram of a one-to-one control mode of the present invention, a remote controller of the invention comprises a transmitting end 10 and a corresponding receiving end 20, and the transmitting end 10 is usually a remote controller body including a first signal transceiver 11 capable of transmitting a plurality of channels and an input device 12, and a trigger instruction of the input device 12 can transmit a remote control signal through a predetermined channel. The transmitting end 10 also can receive the signals transmitted from other ends through another fixed channel and switch its channel for transmitting radio frequency signal according to the foregoing trigger information, so that the next remote control signal will be transmitted through such channel. Further, a manufacture ID is added to the remote control signal for improving the level of identifying the radio frequency signal.

A receiving end 20 is a built-in second signal transceiver 21 of an electronic device for receiving a remote control signal from the transmitting end 10, and automatically switches its receiving channel in sequence or at random if the quality of received signal is evaluated as poor, and transmits a frequency hopping signal to the transmitting end 10 through the foregoing fixed channel, so that the receiving end 20 can synchronously switch its transmitting channel to assure a successful signal transmission.

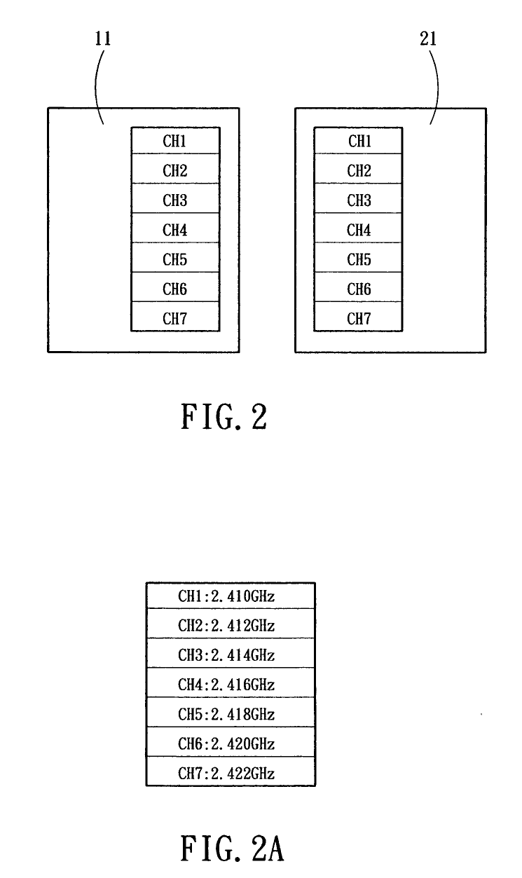

The radio frequency (RF) signal used in the invention is operated at a universal ISM band (2.400 GHz˜2.483 GHz), and thus the transmitting end 10 and the receiving end 20 come with a plurality of channels at predetermined frequencies for transmitting and receiving signals respectively and preventing the interference of other devices of the same frequency band, which will cause a failure at the receiving end 20 for receiving a signal transmitted from the transmitting end 10. Referring to FIG. 2 for the predetermined channels of the transmitting end 10 and the receiving end 20, the transmitting end 10 has 7 predetermined channels (CH1˜CH7). For example, the 7 channels can be set to 2.410 GHz, 2.412 GHz, and so on, and the corresponding receiving end 20 also can be set to the 7 channels at 2.410 GHz, 2.412 GHz, and so on. The frequencies of the channels of both ends 10, 20 are the same (as shown in FIG. 2A), and the number of channels is given as a reference only. Both numbers of channels and frequencies are not intended to be a limitation to the invention. If the quality of received signals is poor, the receiving end 20 will switch its receiving channel automatically in sequence or at random to another receiving channel and will send a frequency hopping signal to the transmitting end 10 through a fixed channel, so that the transmitting end 10 will also switch to that channel, and the next remote control signal will be transmitted through that particular channel, so as to overcome the interference issue. The so-called “poor quality of signals” refers to a threshold of an electric property including but not limited to a signal/noise ratio (S/N ratio). If the noise of a received signal is below the threshold, the quality of signals is determined as poor. The receiving end switches its channel in a sequential order of the channels (which is CH1→CH2→CH3 . . . ) as shown in FIG. 2 or at random without a specific sequential order.

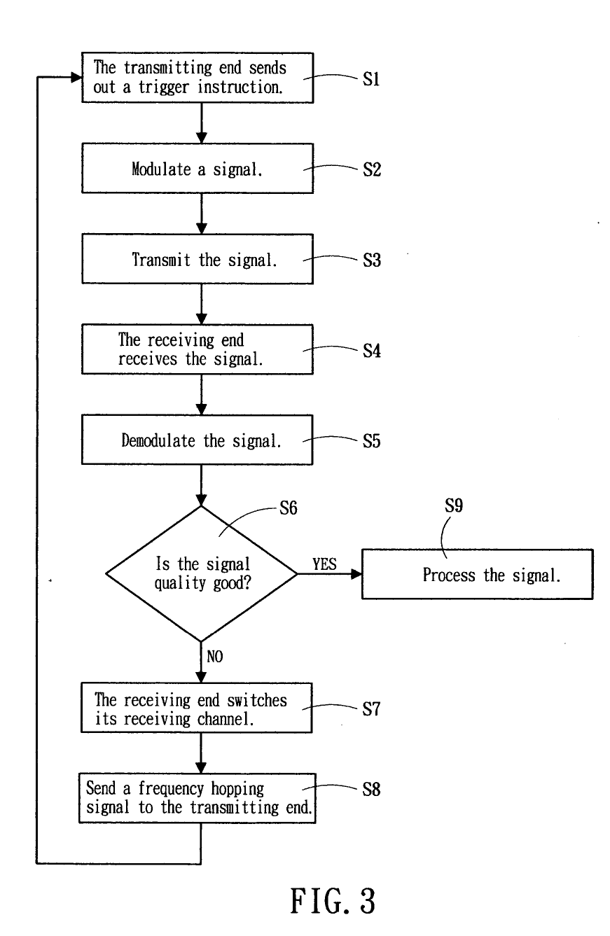

Refer to FIG. 3 for the flow chart and the description of a simulated operation of the present invention. To clearly illustrate the features of the present invention, a remote-control projector is used for the illustration. Firstly, a user holds a remote controller (referred to as the transmitting end) to control the projector at a far end, and the user presses a button corresponding to a trigger instruction S1 on the remote controller. After the corresponding circuit of the remote controller (transmitting end) receives the trigger instruction, the instruction signal is encoded, encrypted, and packeted into a modulated signal (S2) and then sent out from the first signal transceiver 11 (S3).

After the signal is transmitted from the first signal transceiver of the remote controller 11, the second signal transceiver 21 of the receiving end 20 receives the signal (S4), and demodulates the received signal (S5). The signal quality of the demodulated signal is evaluated (S6), and if the signal quality is poor, the second signal transceiver 21 will automatically switch the receiving channel (S7) and send a frequency hopping signal 24 to the transmitting end (S8), such that the transmitting end will switch its transmitting channel to that channel correspondingly, and the next remote control signal will be transmitted through that channel. If there in no signal interference, then the signal processing procedure will be carried out as usual.

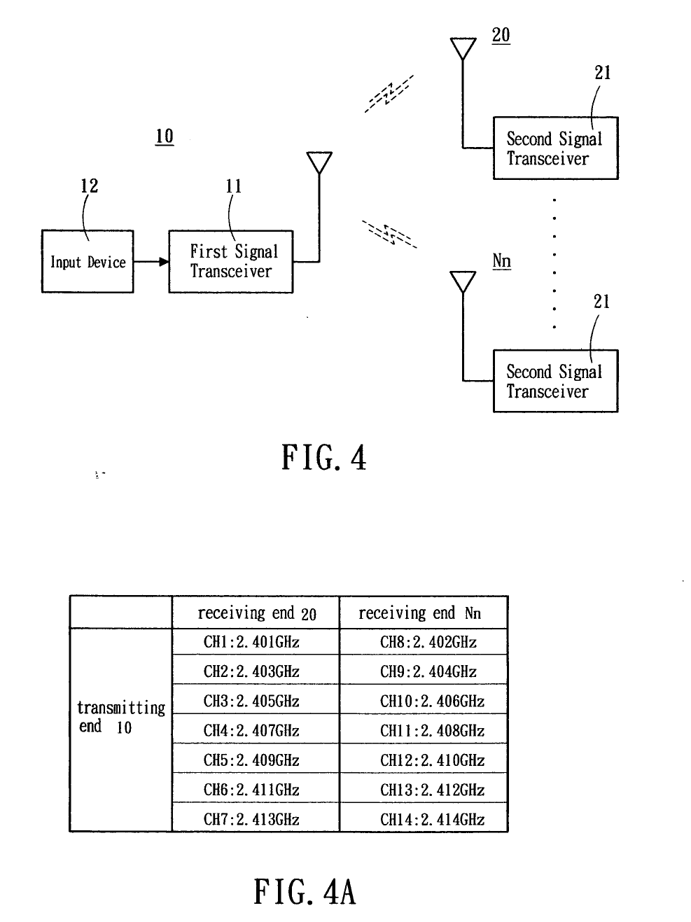

Refer to FIG. 4 for a schematic block diagram of a one-to-many control mode of the present invention. Similarly, the first signal transceiver of the transmitting end 10 can transmit signals to different receiving ends 20, Nn, and the second signal transceiver of the receiving end 20, Nn can receive a remote control signal from the transmitting end 10 and store it in different devices. A manufacture ID is used for identifying the receiving end 20, Nn, and the receiving end 20, Nn has a plurality of channels with different frequency bands. In FIG. 4A, the receiving end 20 has 7 channels (CH1˜CH7) operated at the frequencies of 2.401 GHz, 2.403 GHz, 2.405 GHz, and so on, and the receiving end Nn has 7 channels (CH8˜CH14) operated at the frequencies of 2.402GHz, 2.404 GHz, 2.406 GHz, and so on. The transmitting end 10 also has sufficient channels to cover the range of these frequency bands, so that the receiving end 20, Nn is able to identify the received radio frequency signal. If there are more receiving ends, the channels with equal frequency intervals as described above will be added. If there is an interference with other radio frequency signals in the environment, external noises will be mixed with the signal transmitted from the data transmitter, and thus the receiving end 20, Nn will be unable to receive the remote control signal from the transmitting end 10. If the quality of the received signal is evaluated as poor, the second signal transceiver of the receiving end 20, Nn will automatically switch the receiving channel and send a frequency hopping signal to the transmitting end 10, so that the transmitting end 10 will switch its transmitting channel to that channel accordingly, and the next remote control signal will be transmitted through that channel.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An automatic frequency hopping remote controller, transmitting information by a radio frequency signal, and automatically switching channel thereof when a remote control signal is interfered, and said remote controller comprising:
at least one transmitting end, including a first signal transceiver capable of transmitting a signal from a plurality of channels and receiving a signal from a fixed channel, and an input device, and a remote control signal being transmitted from a predetermined channel by a trigger instruction of said input device; and
a receiving end, including a second signal transceiver capable of receiving a signal from a channel corresponding to said transmitting end and transmitting a signal through said fixed channel, for receiving a remote control signal from said transmitting end, such that if the quality of said received signal is evaluated as poor, said receiving end will automatically switch a receiving channel and send a frequency hopping signal to said transmitting end through said fixed channel to set a transmitting channel to the same channel as that of said receiving channel.

2. The automatic frequency hopping remote controller of claim 1, wherein said channel of said receiving end is switched in a predetermined sequence.

3. The automatic frequency hopping remote controller of claim 1, wherein said channel of said receiving end is switched at random.

4. The automatic frequency hopping remote controller of claim 1, wherein in said receiving ends come with a plural number and are installed separately in different devices.

5. The automatic frequency hopping remote controller of claim 1, wherein said receiving end evaluates said received remote control signal according to a threshold of an electric property and examines whether or not said electric property of said received remote control signal exceeds said threshold as an evaluation standard.

6. The automatic frequency hopping remote controller of claim 5, wherein said electric property is a signal/noise ratio.

7. The automatic frequency hopping remote controller of claim 1, further comprising a manufacture ID to said remote control signal and/or said frequency hopping signal for enhancing the level of identifying said signal.

8. The automatic frequency hopping remote controller of claim 1, wherein said transmitting end further comprises a light indicating lamp.
